(19) United States
(12) Patent Application Publication
(10) Pub. No.: US 2009/0206986 A1
(43) Pub. Date: Aug. 20, 2009

(54) METHOD OF PRESENTING IMS PUBLIC USER IDENTIFY TO RFID APPLICATIONS

(76) Inventors: Shingo Murakami, Kanagawa (JP); Hajime Kasahara, Yokohama (JP); Johan Hjelm, Tokyo (JP); Toshikane Oda, Tokyo (JP)

Correspondence Address: ERICSSON INC., 6300 LEGACY DRIVE, M/S EVR 1-C-11, PLANO, TX, 75024, US

(21) Appl. No.: 12/065,420

(22) PCT Filed: Aug. 29, 2006
(86) PCT No.: PCT/JP2006/317406

§ 371 Date: Apr. 17, 2009

(30) Foreign Application Priority Data
Aug. 31, 2005 (SE) 0501933-6

(51) Int. Cl. G05B 19/00; G08B 13/14

(52) U.S. Cl. 340/5.8; 340/572.1

(57) ABSTRACT

An IMS node communicating with a user node and an information node is provided. The information node is adapted to conduct access control based on IMS Public User Identity. The IMS node comprises: request mediation means for mediating an access request from the user node to the information node by converting a first protocol conforming to IMS into a second protocol interpretable to the information node; and response mediation means for mediating an access response from the information node to the user node by converting the second protocol into the first protocol. The access request includes the IMS Public User Identity and information identity specifying information which the information node is requested to retrieve.

### TECHNICAL FIELD

The present invention relates generally to the field of access control and, more particularly, but not by way of limitation, to access control based on IMS-related user identity conducted by an information repository server.

### BACKGROUND

### Abbreviations

RFID: Radio Frequency Identification

IMS: IP Multimedia Subsystem

UICC: Universal Integrated Circuit Card

SIM: Subscriber Identity Module

USIM: Universal Subscriber Identity Module

ISIM: IP multimedia Services Identity Module

MSISDN: Mobile Subscriber ISDN Number

IMSI: International Mobile Subscriber Identity

UE: User Equipment

ID: Identity

TLS: Transport Layer Security

SCM: Supply Chain Management

Radio Frequency Identification (RFID) is a technology for automating identification of an object. The object is affixed by an RFID tag that stores identification information inside its embedded memory. Short-ranged radio frequency signal is used to transfer such information from the tag to a tag-sensing device called an RFID reader. The main use of this technology has been seen in supply chain management (SCM) application area in order to inventory goods more automatically than the case where inventory has much relied on manual operations. EPCglobal (EPCglobal Inc., http://www.epcglobalinc.org/) is the most active organization attempting to standardize the RFID system used in SCM. Its roles and techniques range from ID numbering assignment, RF (air) protocols, to ID resolution protocols and information access protocols etc.

FIG. 1 shows a high-level architecture and information flow of an RFID application. For the time being, there's no standard protocol between each entities, which depends on the individual choice of each RFID application. The network infrastructure between the entities is build over IP-based network 101 and each protocol operates over some of transport protocols such as TCP, UDP, HTTP or SOAP etc.

However, the basic architecture and information flow in FIG. 1 can be applied for almost all kind of RFID applications. Note the name of each logical entity is also a non-standard name but conveniently named for easy understanding in this document. The brief functional descriptions of the entities are as follows:

RFID reader client 102: It consists of hardware for reading RFID via air interface and software for implementing services to enable data exchange between reader hardware and the servers on the network.

RFID resolution server 103: It resolves the location information (such as IP address, TCP/UDP port number or URL) of an information repository server 104 from a particular RFID value. The representative implementation of this would be ONS (Object Name Service) discussed in EPCglobal.

Information repository server 104: It is a database server that stores related information to the particular RFID value. The representative implementation of this would be EPC-IS (Electronic Product Code Information Service) proposed in EPCglobal.

Tag 105: It consists of a microchip attached to an antenna.

In step S101, the reader client 102 reads an RFID value stored on the tag 105. In step S102, the reader client 102 queries the RFID resolution server 103 about the network location of the information repository server 104 that holds the information associated to this RFID value. In step S103, the reader client 102 requests the information contents associated to this RFID value.

One of security threats in the RFID application is illegal access to the information on the repository server. It is a likely case that sensitive information associated to the certain RFID may be stored on the repository server. Without any defence, it is obvious any information can be accessed unrestrictedly. Thus, it is a common idea that some kind of access control must be applied.

Currently, access control mechanism mentioned above is always conducted by authenticating the reader identifier that is tightly bound to a physical hardware of the reader client. It may be a hardware serial number, MAC address, or possibly IP address assigned to the reader client. By setting one of these reader identifiers as a subject of the authentication, the access control has been performed. “Simple Lightweight RFID Reader Protocol,” P. Krishna et al., Internet Draft, March 2005 (work in progress) specifies how the RFID reader identity should be authenticated in the course of TLS (RFC 2246).

At the present, the important criteria of this access control are put on the fact whether from which asset of reader hardware or from which location the information is being accessed. This hardware-dependent access control is sufficient for the current major RFID applications such as SCM in which the readers are put or located within hardware facilities (e.g., entrances of warehouses, carriers of trucks) in the closed environment.

<Discussions Around Existing Technology>

Problem-1: The filter management of the access control is sometimes troublesome if the reader device is broken, stolen or replaced because the reader identifier on the access control list has to be changed. Even in use of IP addresses of the reader devices as the filtering criteria, it is obvious that frequent updates of the access control list may happen when the reader device obtains IP addresses by DHCP (RFC 2131).

Problem-2: On the other hand, it is foreseen that consumer-oriented RFID applications will be emerging into the market in the near future. There, since everyone will carry a portable RFID reader and a huge number of products around us will be embedded with RFID tags, it will be possible that everybody can reads RFID tags and solicits the information bound to the RFID very easily. This emergence is strongly supported by recent development of mobile phones equipped with RFID reader devices (Nokia Mobile RFID Kit, http://www.nokia.com/nokia/0,,55738,00.html), (http://www.kddi.com/english/corporate/news_release/2005/0324/index.html).

### SUMMARY

It is an object of the present invention to provide a new access control technology in which an access control is conducted based on “user” identities.

This invention provides the nodes, the system, and the method with which such RFID applications or the like can identify users for the purpose of the user identity-based access control.

According to an aspect of the present invention, there is provided with an IMS node communicating with a user node and an information node, wherein the information node is adapted to conduct access control based on IMS Public User Identity, the IMS node comprising: request mediation means for mediating an access request from the user node to the information node by converting a first protocol conforming to IMS into a second protocol interpretable to the information node; and response mediation means for mediating an access response from the information node to the user node by converting the second protocol into the first protocol; wherein the access request includes the IMS Public User Identity and information identity specifying information which the information node is requested to retrieve.

According to another aspect of the present invention, there is provided with an information node communicating with an IMS node, wherein the IMS node is adapted to mediate between a user node and the information node, the information node comprising: receiving means for receiving an access request from the IMS node; retrieving means for retrieving information specified by information identity included in the access request; access control means for determining available information to the retrieving means based on IMS Public User Identity included in the access request; generating means for generating an access response including retrieved information by the retrieving means; and sending means for sending the access response to the IMS node.

According to another aspect of the present invention, there is provided with a user node communicating with an IMS node, wherein the IMS node is adapted to mediate between the user node and an information node, the user node comprising: retrieving means for retrieving information identity specifying information which the information node is requested to retrieve; generating means for generating an access request including IMS Public User Identity and the information identity; sending means for sending the access request to the IMS node; and receiving means for receiving, from the IMS node, an access response including information specified by the information identity.

According to another aspect of the present invention, there is provided with an access control system comprising the IMS node, the information node, and the user node described above.

According to another aspect of the present invention, there is provided with a method for mediating between a user node and an information node, wherein the information node is adapted to conduct access control based on IMS Public User Identity, the method comprising: request mediation step of mediating an access request from the user node to the information node by converting a first protocol conforming to IMS into a second protocol interpretable to the information node; and response mediation step of mediating an access response from the information node to the user node by converting the second protocol into the first protocol; wherein the access request includes the IMS Public User Identity and information identity specifying information which the information node is requested to retrieve.

According to another aspect of the present invention, there is provided with a method for communicating with an IMS node, wherein the IMS node is adapted to mediate between a user node and an information node, the method comprising: receiving step of receiving an access request from the IMS node; retrieving step of retrieving information specified by information identity included in the access request; access control step of determining available information in the retrieving step based on IMS Public User Identity included in the access request; generating step of generating an access response including retrieved information in the retrieving step; and sending step of sending the access response to the IMS node.

According to another aspect of the present invention, there is provided with a method for communicating with an IMS node, wherein the IMS node is adapted to mediate between a user node and an information node, the user node comprising: retrieving step of retrieving information identity specifying information which the information node is requested to retrieve; generating step of generating an access request including IMS Public User Identity and the information identity; sending step of sending the access request to the IMS node; and receiving step of receiving, from the IMS node, an access response including information specified by the information identity.

The main advantage of the present invention is as follows: when a user node requests an access to an information node to retrieve information, IMS node mediates the access request. Therefore, the information node can conduct access control based on IMS Public User identity. Because IMS Public User identity is independent of hardware of the user node, a user can easily change the user node with maintaining the same IMS Public User identity.

This summary of the invention does not necessarily describe all necessary features so that the invention may also be a sub-combination of these described features.

Further features of the present invention will become apparent from the following description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates a high-level architecture and sequence flow of RFID application;

FIG. 2 illustrates user identifiers-based access control on RFID information repository;

FIG. 3 shows a high-level architecture of the invention;

FIG. 4 shows the message sequence flow of the invention;

FIG. 5 illustrates an overview of the procedure performed by the IMS AS;

FIG. 6 shows an example of the INVITE request;

FIG. 7 illustrates an overview of the procedure performed by the information repository server; and

FIG. 8 illustrates an overview of the procedure performed by the UE.

### DETAILED DESCRIPTION

<Overview>

An embodiment of implementing user identity-based access control is described below.

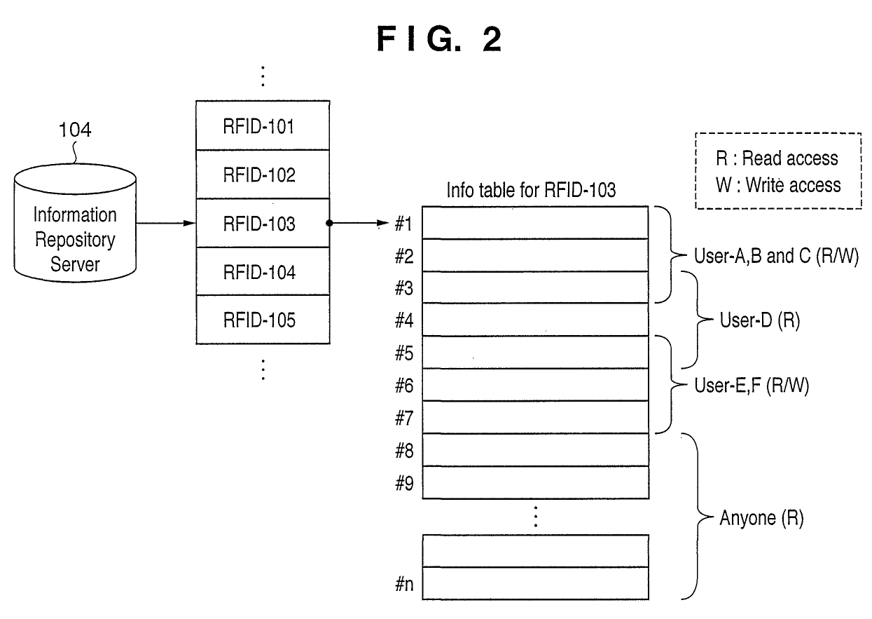

An example scenario of this user identity-based access control can be depicted in FIG. 2.

FIG. 2 shows how information associated with the particular RFID are stored in the repository server 104. In this figure, n items of information are associated with RFID value ‘103’, each of which provides the defined users with Read/Write access privilege. In this example, User-A, B and C can read/write #1˜#3 items of the information, User-D can read #3˜#5 items, User-E and F can read/write #5˜#7 items, and anyone can read #8˜#n items.

In order to realize this user identifier-based access control to RFID information, a method to identify and distinguish users is required by such RFID applications. However, the problem is there's no effective method proposed.

In this embodiment, an effective method to identify and distinguish users is provided using IP Multimedia Subsystem (IMS).

<IP Multimedia Subsystem (IMS)>

3GPP IMS is a standard that enables IMS-enabled mobile terminal users to perform IP-based multimedia communications. IMS consists of two major capabilities that are user registration and session control between registered users' terminals. The user registration capability includes user authentication phase to check if user attempting to register IMS domain has the right to register. For this purpose, IMS supports mechanisms for user authentication based on subscription to relevant IMS service provider. In 3GPP IMS standards, ISIM based subscription and authentication technology is used, and also there is the option in which USIM is used for that purpose.

UICC (Universal Integrated Circuit Card)

Central to the design of 3GPP terminals is the presence of a UICC. The UICC is a removable smart card that contains a limited storage of data. The UICC is used to store, among other things, subscription information, authentication keys, a phone book, and messages. The UICC allows users to easily move their user subscriptions from one terminal to another. The user simply removes the smart card from a terminal and inserts it into another terminal.

A UICC may contain several logical applications, such as a SIM (Subscriber Identity Module), a USIM (Universal Subscriber Identity Module), and an ISIM (IP multimedia Service Identity Module).

ISIM

ISIM (3GPP TS 31.103) is an application present in UICC. ISIM is of especial importance for the IMS, because it contains the collection of parameters that are used for user identification, user authentication etc. when the terminal operates in the IMS. The relevant parameters, among others, stored in ISM are:

Private User Identity: ISIM stores the Private User Identity allocated to the user. There can only one Private User Identity stored in ISIM. This is an identity that is used for authentication purpose only during the registration phase, not for SIP message routing. It is equivalent to what in GSM is known as IMSI; it is never displayed to the user.

Public User Identity: ISIM stores one or more Public User Identities allocated to the user in the form of SIP URI or TEL URL. They publicly represent the user identities in the IMS. The user can choose one preferred public user identity when creating a session and the user can be uniquely recognized with the Public User Identity.

USIM

USIM (3GPP TS 31.102) is another example of an application that resides in UICC. USIM provides another set of parameters which include user subscriber information, authentication information, payment methods etc. A USIM is required if a CS (Circuit Switched) or PS (Packet Switched) terminal needs to operate in a 3G network. USIM stores, among others, the following parameters:

IMSI: IMSI is an identity assigned to each user. This identity is not visible to users themselves, but only to the network. IMSI is used as the user identification for authentication purpose.

The Private User Identity is the equivalent of the IMSI in the IMS.

MSISDN: This field stores one or more telephone numbers allocated to the user. A Public User Identity is the equivalent of the MSISDN in the IMS.

In case the IMS terminal is equipped with a UICC that does not contain an ISIM application, the user can still register with the IMS network. Of special interest in the USIM from the IMS perspective is the IMSI. The terminal extracts the IMSI from the USIM in order to build a temporary Private User Identity and a temporary Public User Identity etc. These parameters are only used during registration, re-registration, and deregistration procedures. When the user is eventually registered the Serving—Call and Session Control Function (S-CSCF) sends a collection of the regular Public User Identities allocated to the user. The IMS terminal only uses these Public User Identities for any SIP traffic other that REGISTER requests. As a consequence, the temporary identities are never known or used outside the home networks (e.g. in a session setup).

IMS Application Server

In the IMS network, there will be several Application Servers; each specialized in providing a particular service. All these Application Servers are characterized by implementing a SIP interface, which is called IMS Service Control (ISC), toward the S-CSCF. The Application Servers can be located in the home network or in a third-party service provider network. When an Application Server is located in the home networks, it can optionally implement an interface to the HSS. The implementation of the interface depends on whether the actual service logic needs to further interact with the HSS or not. The optional interface from the Application Server to the HSS is ‘Sh’, and the protocol is based on Diameter (RFC 3588). If the Application Server is located in a third-party service provider network, it cannot implement the Sh interface in the HSS, as Sh is just an intra-operator interface.

### DETAILED DESCRIPTION OF THE EMBODIMENT

As described above, end users with the IMS terminals can identify each other with the Public User Identity. An IMS Application Server can also identify each end user with the Public User Identity. The basic idea of this invention is to present these Public User Identities used in the IMS to the information repository server so that it can perform the user identity-based access control with these user identities.

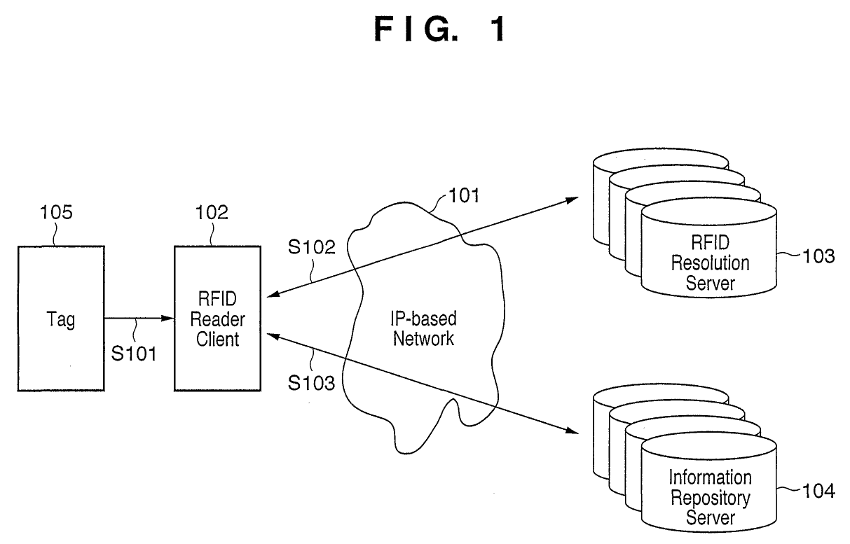

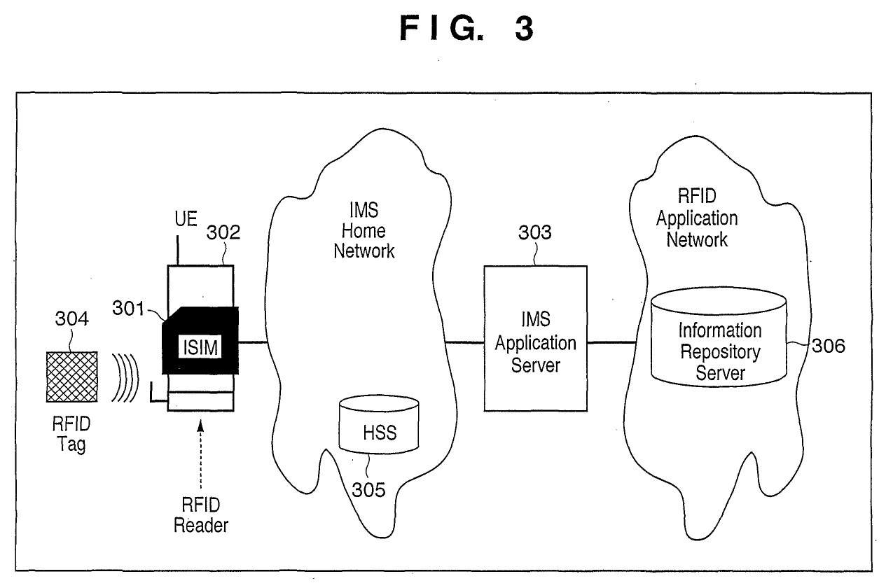

FIG. 3 shows the high-level architecture of the invention. The differences from FIG. 1 are as follows:

The ISIM 301 (and/or USIM) inserted UE 302 has RFID reader client functionality.

The dedicated IMS Application Server 303 mediates RFID information request from the UE 302, which is done directly between the reader client 102 and the information repository server 104 in the past.

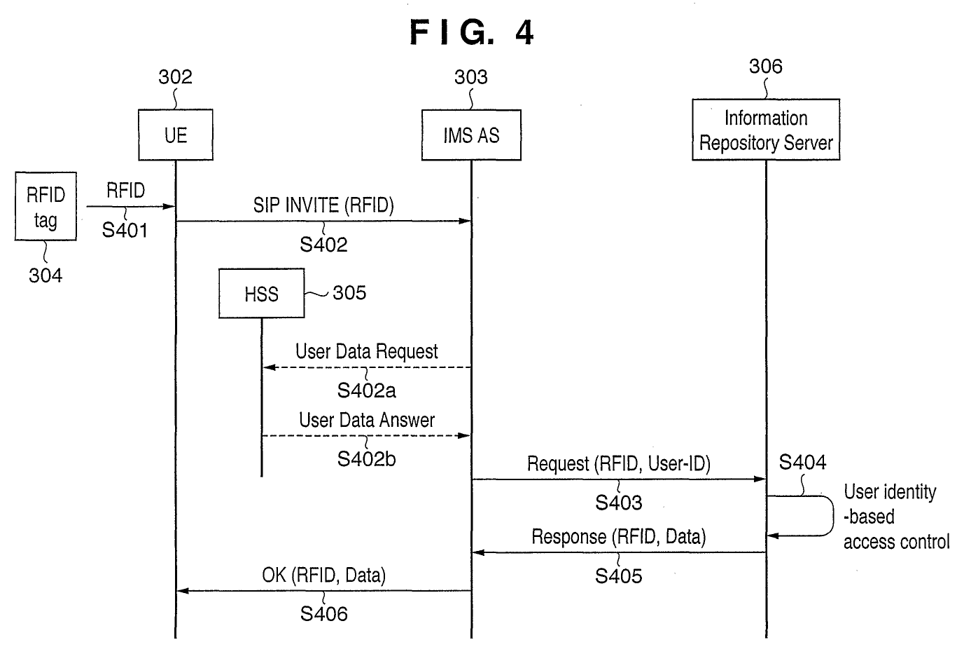

FIG. 4 shows the message sequence flow of the invention. First of all, the IMS terminal (i.e. UE 302) reads the RFID value from the RFID tag 304 (S401 in FIG. 4). The IMS Application Server (AS) 303 receives a SIP INVITE message from the IMS terminal 302, soliciting the RFID-associated information (S402 in FIG. 4). Note that other methods such as OPTION and SUBSCRIBE may also be used, but are not described here.

Here, the Public User Identity, which was the asserted identity of the user using the IMS terminal, is present in P-Asserted-Identity header in the INVITE message.

Optionally, if the AS 303 can communicate with the HSS 305 through the Sh interface (i.e., the AS 303 is located within the same IMS operator's network), then the AS 303 can pull more user identity information out from the HSS (S402a, S402b in FIG. 4). In this case, the AS 303 can present different Public User Identity (SIP URI, TEL URL) or MSISDN owned by this user to the information repository server 306. Which user identity format is used depends on the configuration of the information repository server 306.

Then, the AS 303 mediates the request by converting the protocols from the IMS to RFID application network and sending a request message to the information repository server 306 presenting the RFID value and the user identity, for example, in the form of SIP URI (S403 in FIG. 4).

By using this presented user identity, the information repository server can perform the user identity-based access control against the requested information (S404 in FIG. 4). Again, the user identity presented to the information repository server is derived from the ISIM or USIM application on the UICC that has to be inserted into the RFID reader-enabled UE 302. It should be noted that the access control includes authorization but does not include authentication. That is, the UE 302 is authenticated to access the IMS infrastructure comprising the AS 303 in advance, for example, when the UE 302 is turned on (not shown in FIG. 4). Then, in step S404, whether or not the authenticated UE is allowed to access certain information is determined based on the user identity (authorization).

The information repository server sends a response (i.e., e.g., the requested information) to the UE 302 via IMS AS 303 (S405, S406 in FIG. 4), or directly to the UE 302 (not shown).

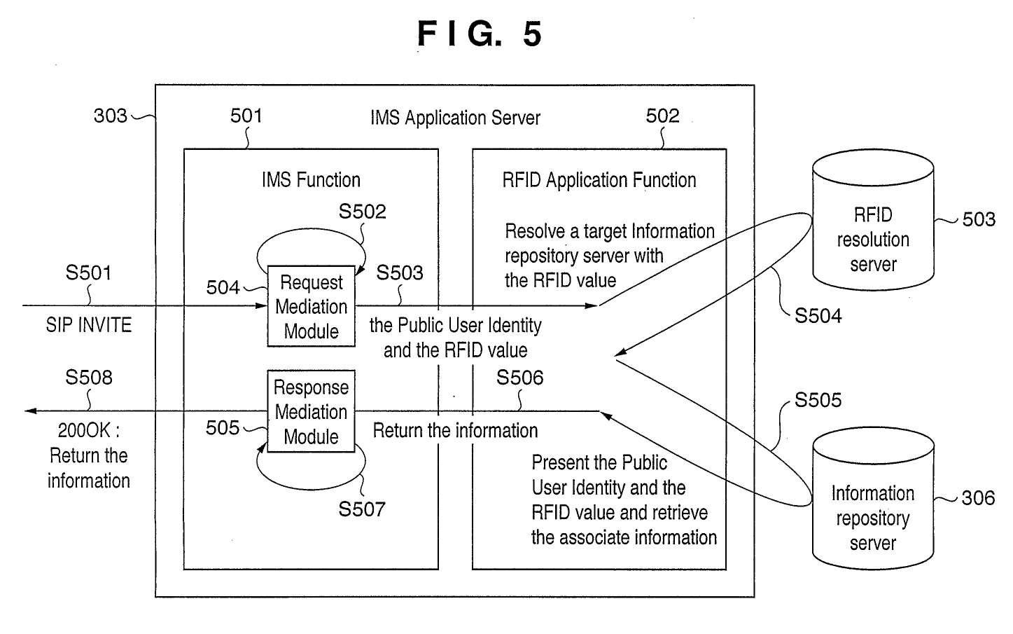

FIG. 5 illustrates an overview of the procedure performed by the AS 303. The AS 303 comprises two functional elements: the IMS Function 501 and the RFID Application Function 502.

The IMS Function 501 comprises a request mediation module 504 and a response mediation module 505. These modules may be implemented by a computer program executed by a CPU (not shown) of AS 303. The request mediation module 504 mediates an access request and the response mediation module 505 mediates an access response between the UE 302 and the information repository server 306 (as will hereinafter be described in detail).

The following outlines the procedure:

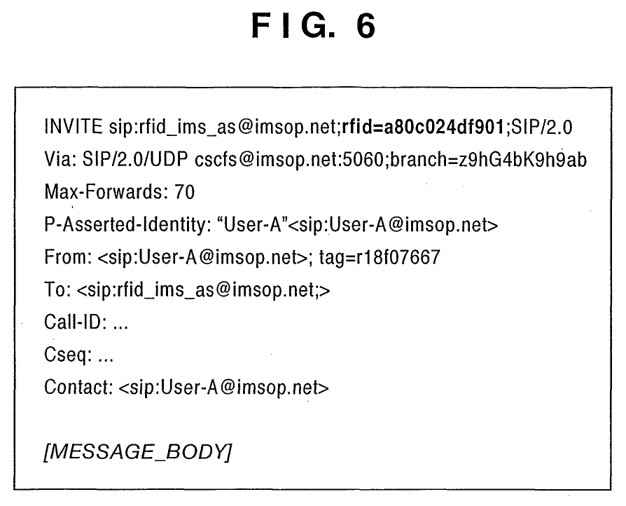

In step S501, the IMS Function 501 receives an INVITE request, which is addressed and routed to the AS 303. In FIG. 6, an example of the INVITE request is shown. The Request-URI is filled with the Public Service Identity of the AS 303 so that the INVITE is routed to this AS 303 via the IMS infrastructure. In this example, “sip:rfid_ims_as@imsop.net” is used. The Request-URI also contains a special URI parameter named ‘rfid’ that holds the RFID value so that the AS 303 can receive the RFID value. That is, RFID value specifies information which the UE 302 wants the information repository server 306 to retrieve. Alternatively, any of SIP headers or a message body may be used for the purpose, which contains the RFID value as well. Since any SIP entity must ignore unknown URI parameters such as ‘rfid’, this URI parameter should not affect operation of other IMS entities (e.g. CSCFs). It should also be noted that P-Asserted-Identity is presented in the INVITE request by which the AS 303 is granted, by the IMS infrastructure, the authenticity of a request source of the INVITE.

In step S502, the request mediation module 504 in the IMS Function 501 extracts both the Public User Identity from the P-Asserted-Identity header field and the RFID value from the ‘rfid’ URI parameter. Then, the request mediation module 504 generates a HTTP Request message comprising the extracted Public User Identity and RFID value. In other words, the request mediation module 504 transforms the SIP INVITE message (which is a kind of a SIP Request message) into the HTTP Request message. This step is necessary because the UE 302 sends an access request using a SIP protocol, whereas the information repository server 306 receives the access request using a different protocol such as HTTP.

In step S503, the IMS Function 501 invokes the RFID Application Function 502 with the transformed access request (i.e. the HTTP Request message).

In step S504, the RFID Application Function 502 may need to contact an RFID resolution server 503 to determine a target location of the information repository server 306 (e.g. a HTTP URL) as discussed above. The location of the RFID resolution server 503 may be pre-configured in the RFID Application Function 502.

In step S505, the RFID Application Function 502 requests the Information repository server 306 in order to retrieve the information associated with the RFID value. The request message generated in step S502 at least contains the Public User Identity and the RFID value so that the Information Repository server 306 can perform the access control based on the Public User Identity and send the information associated with the requested RFID value, respectively. The access control is done in order to determine available information.

In step S506, the RFID Application Function 502 internally returns the received information, which was received in the form of a HTTP Response message, to the IMS Function 501.

In step S507, the response mediation module 505 in the IMS Function 501 extracts the received information from the HTTP Request message. Then, the response mediation module 505 generates a 200 OK message (a kind of a SIP Response message) comprising the extracted received information. In other words, the response mediation module 505 transforms the HTTP Response message into the SIP Response message. This step is necessary because of the similar reason as step S502.

In step S508, the IMS Function 501 returns the received information to the request source over 200 OK.

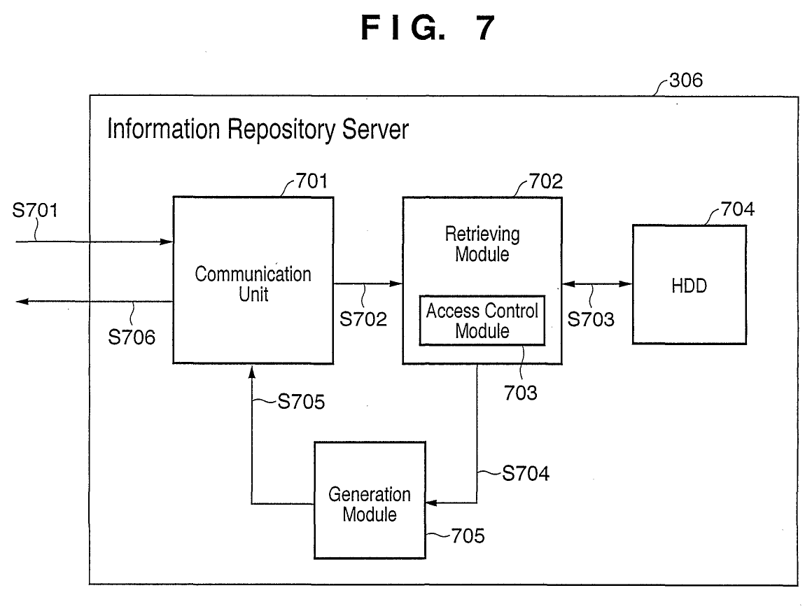

FIG. 7 illustrates an overview of the procedure performed by the information repository server 306. The information repository server 306 comprises a communication unit 701 and a HDD (Hard Disk Drive) 704. The information repository server 306 also comprises a retrieving module 702, an access control module 703, and a generation module 705. These modules may be implemented by a computer program executed by a CPU (not shown) of the information repository server 306.

In step S701, the communication unit 701 receives an access request from the AS 303.

In step S702, communication unit 701 provides the retrieving module 702 with the access request.

In step S703, the retrieving module 702 accesses the HDD 704 and retrieves the information associated with the information identity included in the access request. The retrieved information may consist of plural pieces of information; each piece has an access control attribute indicating which user can access the piece.

In step S704, the access control module 703 compares the access control attributes of the retrieved information with the Public User Identity included in the access request, and determines which pieces of the retrieved information is available to the requesting user. For example, in case that the information identity (RFID value) is ‘103’ and the Public User Identity indicates User-A, items #1˜#3 and #8˜#n are available (refer to FIG. 2). Then the retrieving module 702 provides the available pieces of the retrieved information with the generation module 705.

In step S705, the generation module 705 generates an access response including the pieces of information provided in step S704. Then the generation module 705 provides the access response with the communication unit 701. The access response is, for example, in the form of a HTTP Response message.

In step S706, the communication unit 701 sends the access response to the AS 303.

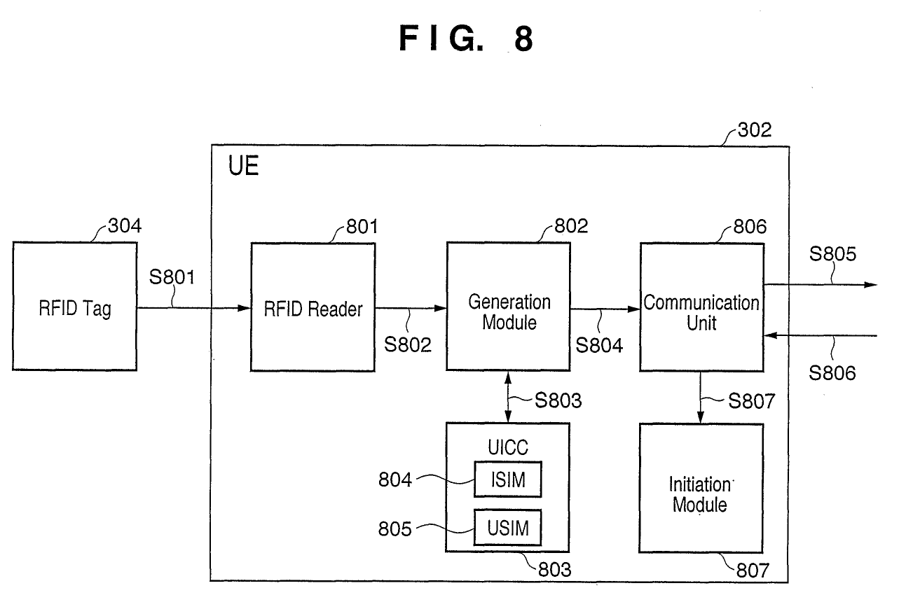

FIG. 8 illustrates an overview of the procedure performed by the UE 302. The UE 302 comprises an RFID Reader 801, UICC 803 which comprises ISIM 804 and/or USIM 805, and a communication unit 806. The UE 302 also comprises a generation module 802 and an initiation module 807. These modules may be implemented by a computer program executed by a CPU (not shown) of the UE 302.

In step S801, the RFID Reader 801 reads the RFID Tag 304 and retrieves an RFID value.

In step S802, the RFID Reader 801 provides the retrieved RFID value with the generation module 802.

In step S803, the generation module 802 retrieves Public User Identity from the UICC 803. The Public User Identity may be maintained in the ISIM 804, or built using IMSI maintained in the USIM 805.

In step S804, the generation module 802 generates an access request including the retrieved RFID value and the retrieved Public User Identity. Then, the generation module 802 provides the access request with the communication unit 806. The access request is, for example, in the form of an INVITE message shown in FIG. 6.

In step S805, the communication unit 806 sends the access request to the AS 303.

In step S806, the communication unit 806 receives the access response in reply to the access request.

The UE 302 can utilize the received access response in various ways. For example, in step S807, the initiation module 807 retrieves the SIP URI from the access response and initiates a SIP session using the retrieved SIP URI.

The present invention can work as an effective mechanism to deliver IP-based multimedia services to users by combining the IMS with RFID applications, particularly when RFIDs are associated with multimedia services (see step S807 in FIG. 8).

For example, an RFID on a business card and/or consumer product may be associated with a VoIP service with a SIP URI of a customer or a help desk. In this case, the AS 303 (that converts the requested RFID value into the associated SIP URI) establishes a VoIP session automatically between the requesting user (represented by the Public User Identity of the INVITE) and the customer/help desk (represented by the SIP URI associated with the RFID value).

Another example would be that an RFID on a CD/DVD package might be associated with a content streaming service with a SIP URI that represents content and its streaming server. In this case, the AS 303 (that converts the requested RFID value to the associated SIP URI) establishes a video/audio streaming session automatically between the requesting user (represented by the Public User Identity of the INVITE) and the streaming server (represented by the SIP URI associated with the RFID value).

Another example would be that the UE 302 could obtain a coupon (an electronic coupon) for certain goods just by reading an RFID tag. Suppose the certain goods in a supermarket are affixed with RFID tags. The supermarket offers special membership service. A customer needs to tell his/her IMS Public User Identity (e.g. sip:User-A@imsop.net as described in FIG. 6) to the supermarket so that the customer signs up to the membership service. Then the customerID (i.e. IMS Public User Identity) is registered in an access control list on an information repository server 306 managed by the supermarket.

If the customer finds favorite goods affixed with a RFID tag in the supermarket, the membership service enables him/her to download the detailed product information and its special coupon (which may be included in the OK message described in FIG. 4) by simply reading the RFID tag with his/her UE with RFID-reader. This indicates that other customers who don't sign up for the membership service cannot retrieve the coupons because their identities are not on the access control list of the repository server 306. The coupon may be displayed on the display of the UE and the customer can use it by, for example, showing the display to a clerk.

As the examples show, the present invention enables the IMS AS to establish variety of SIP sessions between the requesting user and the multimedia services associated with the RFID value (by using e.g. third party call control technique (Best Current Practices for Third Party Call Control in the SIP, RFC 3725)). This is possible because the IMS AS has both the IMS Function and RFID Application Function. This will benefit the user in that the user can automatically be a part of such a multimedia service only by sending RFID value to the IMS AS because the IMS AS performs all the necessary coordination of the multimedia service delivery ranging from converting the RFID value to e.g. SIP URI and establish a multimedia session between the users and the SIP URI associated with the RFID value.

Alternatively, user equipment may be configured to establish a SIP session using SIP URI (or TEL URL) associated with a RFID value. That is, when user equipment receives a SIP Response message including SIP URI, it may automatically initiate a SIP session with the SIP entity represented by the SIP URI.

### ADVANTAGES OF THE INVENTION

The main advantage of the invention is just providing the valid method for RFID applications to securely identify users to perform user identity-based access control to the information repository server. Also, the following benefits would come together.

(1) RFID Applications Do Not Need Their Own Naming and Authentication Infrastructure of User Identity

Even without involvement of the IMS network, it is still possible that RFID applications can perform the user identity-based access control to the information repository servers by introducing both their own naming and authentication systems of user identity. However, it must require too much cost for RFID applications to prepare and manage the naming and authentication infrastructure on its own account with a huge number of RFID reader-embedded personal devices such as cellular phones.

If the RFID application relies on and makes reuse of the existing IMS naming and authentication infrastructure, development and management cost of the user identity-based access control can be drastically decreased.

(2) User Identities are Independent of RFID Reader Hardware

The ISIM or USIM-based naming and authentication mechanism of user identity in the IMS is independent of hardware of the UE. The users can have flexibility in changing the UE hardware by simply inserting their own UICC with ISIM or USIM to desired UE hardware. The users and RFID applications can inherit this flexibility as it is, even when RFID-reader device is put on the UE hardware. They can be free against failure of the reader hardware and can easily change to new extended featured reader hardware without any change to user identity information.

Although RFID tag has been exemplified as a source of identity that specifies information stored in the information repository server, it should be noted that other sources, such as bar code and QR-code, are also adoptable. Accordingly, an RFID reader may be replaced by a bar code reader, a QR-code reader, etc.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An IMS node communicating with a user node and an information node, wherein the information node is adapted to conduct access control based on IMS Public User Identity, said IMS node comprising:
request mediation means for mediating an access request from the user node to the information node by converting a first protocol conforming to IMS into a second protocol interpretable to the information node; and
response mediation means for mediating an access response from the information node to the user node by converting the second protocol into the first protocol,
wherein the access request includes the IMS Public User Identity and information identity specifying information which the information node is requested to retrieve.

2. The IMS node according to claim 1, wherein said second protocol is Hyper Text Transfer Protocol (HTTP).

3. The IMS node according to claim 2, wherein the request mediation means receives the access request from the user node in the form of a SIP Request message, transforms the SIP Request message into a HTTP Request Message, and sends the access request to the information node in the form of the HTTP Request Message.

4. The IMS node according to claim 2, wherein the response mediation means receives the access response from the information node in the form of a HTTP Response message, transforms the HTTP Response message into a SIP Response Message, and sends the access response to the user node in the form of the SIP Response Message.

5. An information node communicating with an IMS node, wherein the IMS node is adapted to mediate between a user node and the information node, said information node comprising:
receiving means for receiving an access request from the IMS node;
retrieving means for retrieving information specified by information identity included in the access request;
access control means for determining available information to the retrieving means based on IMS Public User Identity included in the access request-generating means for generating an access response including retrieved information by the retrieving means; and
sending means for sending the access response to the IMS node.

6. The information node according to claim 5, wherein:
the information specified by the information identity includes one or more pieces of information. each piece having an access control attribute; and
the access control means determines the available information by comparing the access control attribute of the each piece with the IMS Public User Identity.

7. The information node according to claim 5, wherein the receiving means receives the access request from the IMS node in the form of a HTTP Request Message.

8. The information node according to claim 5, wherein the sending means sends the access response to the IMS node in the form of a HTTP Response message.

9. A user node communicating with an IMS node wherein the IMS node is adapted to mediate between the user node and an information node, said user node comprising:
retrieving means for retrieving information identity specifying information which the information node is requested to retrieve;
generating means for generating an access request including IMS Public User Identity and the information identity:
sending means for sending the access request to the IMS node; and
receiving means for receiving from the IMS node, an access response including information specified by the information identity.

10. The user node according to claim 9, wherein:
the user node is embedded with an RFID reader
the information identity is stored in RFID tag; and
the retrieving means is implemented with the RFID reader and retrieves the information identity from the RFID tag.

11. The user node according to claim 9, wherein the user node is a mobile terminal.

12. The user node according to claim 11, further comprising a UICC including an ISIM,
wherein the IMS Public User Identity is maintained in the ISIM.

13. The user node according to claim 11, further comprising a UICC including an USIM,
wherein the IMS Public User Identity is retrieved using IMSI maintained in the USIM.

14. The user node according to claim 9, wherein the sending means sends the access request to the IMS node in the form of a SIP Request Message.

15. The user node according to claim 9, wherein the receiving means receives the access response from the IMS node in the form of a SIP Response Message.

16. The user node according to claim 9, wherein the access response includes SIP URI and/or TEL URL,
further comprising initiation means for initiating a SIP session using the SIP URI or the TEL URL.

17. An access control system comprising:
an IMS node;
an information node; and
an user node.

18. A method for mediating between a user node and an information node, wherein the information node is adapted to conduct access control based on IMS Public User Identity, said method comprising:
request mediation step (S502) of mediating an access request from the user node to the information node by converting a first protocol conforming to IMS into a second protocol interpretable to the information node; and
response mediation step (S507) of mediating an access response from the information node to the user node by converting the second protocol into the first protocol;
wherein the access request includes the IMS Public User Identity and information identity specifying information which the information node is requested to retrieve.

19. The method according to claim 18, wherein said second protocol is Hyper Text Transfer Protocol (HTTP).

20. The method according to claim 19, wherein, in the request mediation step (S502), the access request is received from the user node in the form of a SIP Request message, the SIP Request message is transformed into a HTTP Request Message, and the access request is sent to the information node in the form of the HTTP Request Message.

21. The method according to claim 19, wherein. in the response mediation step (S507), the access response is received from the information node in the form of a HTTP Response message, the HTTP Response message is transformed into a SIP Response Message. and the access response is sent to the user node in the form of the SIP Response Message.

22. A method for communicating with an IMS node wherein the IMS node is adapted to mediate between a user node and an information node, said method comprising:
receiving step (S701) of receiving an access request from the IMS node;
retrieving step (S703) of retrieving information specified by information identity included in the access request;
access control step (S704) of determining available information in the retrieving step (S703) based on IMS Public User Identity included in the access request;
generating step (S705) of generating an access response including retrieved information in the retrieving step (S703); and
sending step (S706) of sending the access response to the IMS node.

23. The method according to claim 22, wherein:
the information specified by the information identity includes one or more pieces of information, each piece having an access control attribute; and
in the access control step (S704). the available information is determined by comparing the access control attribute of the each piece with the IMS Public User Identity.

24. The method according to claim 22, wherein in the receiving step (S701), the access request is received from the IMS node in the form of a HTTP Request Message.

25. The method according to claim 22, wherein, in the sending step (S706), the access response is sent to the IMS node in the form of a HTTP Response message.

26. A method for communicating with an IMS node, wherein the IMS node is adapted to mediate between a user node and an information node, said user node comprising:
retrieving step (S801) of retrieving information identity specifying information which the information node is requested to retrieve:
generating step (S803, S804) of generating an access request including IMS Public User Identity and the information identity;
sending step (S805) of sending the access request to the IMS node and receiving step (S806) of receiving, from the IMS node, an access response including information specified by the information identity.

27. The method according to claim 26, wherein:
the user node is embedded with an RFID reader;
the information identity is stored in RFID tag and in the retrieving step (S801), the RFID reader retrieves the information identity from the RFID tag.

28. The method according to claim 26, wherein the user node is a mobile terminal.

29. The method according to claim 28, wherein:
the user node comprises a UICC including an ISIM; and
the IMS Public User Identity is maintained in the ISIM.

30. The method according to claim 28, wherein:
the user node comprises a UICC including an USIM; and
the IMS Public User Identity is retrieved using IMSI maintained in the USIM.

31. The method according to claim 26 wherein, in the sending step (S805), the access request is sent to the IMS node in the form of a SIP Request Message.

32. The method according to claim 26 wherein, in the receiving step (S806), the access response is received from the IMS node in the form of a SIP Response Message.

33. The method according to claim 26 wherein the access response includes SIP URI and/or TEL URL,
further comprising initiation step (S807) of initiating a SIP session using the SIP URI or the TEL URL.
